(19) United States
(12) Patent Application Publication
(10) Pub. No.: US 2015/0093517 A1
(43) Pub. Date: Apr. 2, 2015

(54) METHOD OF PRODUCING ELECTROCONDUCTIVE MEMBER FOR ELECTROPHOTOGRAPHY

(71) Applicant: CANON KABUSHIKI KAISHA, Tokyo (JP)

(72) Inventors: Norifumi Muranaka, Yokohama-shi (JP); Satoru Yamada, Numazu-shi (JP); Kazuhiro Yamauchi, Suntou-gun (JP); Yuichi Kikuchi, Susono-shi (JP); Tetsuo Hino, Yamato-shi (JP)

(21) Appl. No.: 14/490,829

(22) Filed: Sep. 19, 2014

(30) Foreign Application Priority Data
Sep. 27, 2013 (JP) 2013-202660

(51) Int. Cl. G03G 7/00; C23C 18/00

(52) U.S. Cl. CPC G03G 7/00; C23C 18/00
USPC 427/562; 427/58

(57) ABSTRACT

Provided is an electroconductive member for electrophotography, having a fiber layer on the outer peripheral surface of an electroconductive substrate, the electroconductive member having good adhesion property between the electroconductive substrate and the fiber layer. Specifically, provided is a method of producing an electroconductive member for electrophotography, the electroconductive member comprising an electroconductive substrate; and a fiber layer thereon, the fiber layer comprising fibers which have an average fiber diameter of from 0.01 μm to 40 μm, and are adhered to an outer peripheral surface of the electroconductive substrate, the method comprising the steps of: producing the fibers in a space between a nozzle and the outer peripheral surface of the electroconductive substrate by ejecting a liquid containing a raw material for the fibers from the nozzle toward the electroconductive substrate; and adhering the fibers to the outer peripheral surface of the electroconductive substrate.

### BACKGROUND OF THE INVENTION

1. Field of the Invention

The present invention relates to a method of producing an electroconductive member for electrophotography.

2. Description of the Related Art

In an electrophotographic apparatus as an image forming apparatus adopting an electrophotographic system, an electroconductive member has been used in various applications including an electroconductive roller such as a charging roller, a developing roller, or a transfer roller. Such electroconductive member is largely involved in the performance of the electrophotographic apparatus, and hence not only good electrical characteristics but also durability has been required for the member.

A method involving forming a fiber layer on the surface of the electroconductive member is available as an example of improvements in the electrical characteristics or an improvement in the durability. For example, Japanese Patent Application Laid-Open No. 2007-163974 discloses a method involving forming a nonwoven fabric layer on an electroconductive mandrel.

When the fiber layer such as a nonwoven fabric is formed on the surface of an electroconductive substrate, a gap or a step difference may occur between the fiber layer and the electroconductive substrate. Accordingly, when the resultant is used as the electroconductive member, an image harmful effect occurs in some cases. In addition, the fiber layer peels from the electroconductive substrate owing to a difference in expansion coefficient or water absorption coefficient between the electroconductive member and the fiber layer caused by a change in temperature or humidity in some cases.

### SUMMARY OF THE INVENTION

In view of such technological background, the present invention is directed to providing a method of producing an electroconductive member for electrophotography, having a fiber layer having good adhesion property with an electroconductive substrate.

According to one aspect of the present invention, there is provided a method of producing an electroconductive member for electrophotography, the electroconductive member comprising an electroconductive substrate; and a fiber layer thereon, the fiber layer comprising fibers which have an average fiber diameter of from 0.01 μm to 40 μm, and are adhered to an outer peripheral surface of the electroconductive substrate, the method comprising the steps of: (1) producing the fibers in a space between a nozzle and the outer peripheral surface of the electroconductive substrate by ejecting a liquid containing a raw material for the fibers from the nozzle toward the electroconductive substrate; and (2) adhering the fibers to the outer peripheral surface of the electroconductive substrate.

According to another aspect of the present invention, there is provided a method of producing an electroconductive member for electrophotography, the electroconductive member comprising an electroconductive substrate; and a fiber layer thereon, the fiber layer comprising fibers which have an average fiber diameter of from 0.01 μm to 40 μm, and are adhered to an outer peripheral surface of the electroconductive substrate, the method comprising the steps of: producing the fibers in a space between a nozzle and the outer peripheral surface of the electroconductive substrate by ejecting a liquid containing a raw material for the fibers from the nozzle toward the electroconductive substrate by applying a voltage to the nozzle; and adhering the fibers to the outer peripheral surface of the electroconductive substrate.

Further features of the present invention will become apparent from the following description of exemplary embodiments with reference to the attached drawings.

### BRIEF DESCRIPTION OF THE DRAWINGS

FIGS. 1A and 1B are each a view illustrating an example of an electroconductive member (charging member) for electrophotography to be produced by a method of producing an electroconductive member for electrophotography according to the present invention.

FIG. 2 is a schematic view of an electrospinning apparatus to be used in the method of producing an electroconductive member for electrophotography according to the present invention.

FIG. 3 is a schematic sectional view of a process cartridge for electrophotography.

FIG. 4 is a schematic construction view of an electrophotographic image forming apparatus.

### DESCRIPTION OF THE EMBODIMENTS

Preferred embodiments of the present invention will now be described in detail in accordance with the accompanying drawings.

As described above, the inventors of the present invention have found that when a production method of the present invention includes the steps of: producing the fibers in a space between a nozzle and the outer peripheral surface of the electroconductive substrate by ejecting a liquid containing a raw material for fibers from the nozzle toward an electroconductive substrate; and adhering the fibers to the outer peripheral surface of the electroconductive substrate, adhesion property between the electroconductive substrate and the fiber layer, and adhesion property between the fibers in the fiber layer improve.

The inventors of the present invention have considered the reason why the adhesion properties improve to be as described below. When the fiber layer formed in advance is bonded to the surface of the electroconductive substrate, the fiber layer is present as a self-supporting film. Accordingly, the shape followability of the fiber layer to the surface shape of the electroconductive substrate is poor, and hence adhesion unevenness, a gap, or a step difference due to, for example, a seam of the fiber layer is liable to occur between the fiber layer and the electroconductive substrate. In particular, when the fiber layer or the electroconductive substrate is expanded or shrunk by changes in temperature and humidity, peeling occurs owing to a difference between their respective shape changes in some cases. In view of the foregoing, through the steps of the present invention, a fiber layer in conformity with the surface shape of the electroconductive substrate is formed, and hence the adhesion unevenness, the gap, or the step difference hardly occurs. Further, the fiber layer is formed immediately after the production of the fibers from the liquid containing the raw material for the fibers. Accordingly, adhesiveness between the fibers improves. In addition, after the fibers have adhered to the electroconductive substrate, the volume shrinkage of the fibers occurs to additionally improve the adhesiveness. Accordingly, an adhesive force between the fiber layer and the electroconductive substrate, and an adhesive force between the fibers may increase. In addition, the thickness of the fiber layer can be arbitrarily controlled, and hence a seamless and uniform fiber layer can be formed.

Hereinafter, an electroconductive member for electrophotography to be produced by the production method of the present invention is described in detail. Although the description is given below by taking a charging member (charging roller) as a typical example of the electroconductive member, the shape and applications of the electroconductive member in the present invention are not limited to such charging member (charging roller).

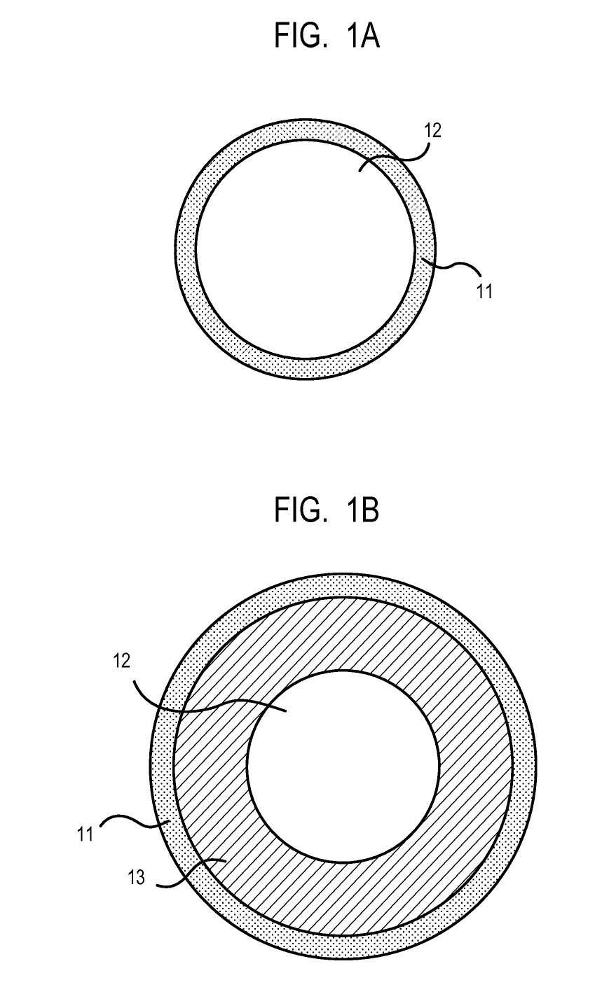

FIGS. 1A and 1B are each a schematic view of a charging member obtained by the production method according to the present invention. The charging member has a fiber layer on the outer peripheral surface of an electroconductive substrate. The charging member can be of, for example, a construction formed of a mandrel 12 as the electroconductive substrate and a fiber layer 11 formed on the outer peripheral surface of the mandrel as illustrated in FIG. 1A. The charging member may be of a construction formed of the mandrel 12, an electroconductive resin layer 13 formed on the outer peripheral surface of the mandrel, and the fiber layer 11 formed on the outer peripheral surface of the layer as illustrated in FIG. 1B. As described above, the electroconductive substrate may have the electroconductive resin layer on the outer peripheral surface of the electroconductive mandrel. It should be noted that the electroconductive resin layer 13 may be of a multilayer construction as required to the extent that the effects of the present invention are not impaired.

<Electroconductive Substrate>

[Electroconductive Mandrel]

A mandrel appropriately selected from those known in the field of an electroconductive member for electrophotography can be used as the electroconductive mandrel. For example, a cylindrical material obtained by plating the surface of a carbon steel alloy with nickel having a thickness of about 5 μm can be used.

[Electroconductive resin Layer]

A rubber material, a resin material, or the like can be used as a material constituting the electroconductive resin layer. The rubber material is not particularly limited and a rubber known in the field of an electroconductive member for electrophotography can be used. Specific examples of such rubber include an epichlorohydrin homopolymer, an epichlorohydrin-ethylene oxide copolymer, an epichlorohydrin-ethylene oxide-allyl glycidyl ether terpolymer, an acrylonitrile-butadiene copolymer, a hydrogenated product of an acrylonitrile-butadiene copolymer, silicone rubber, acrylic rubber, and urethane rubber. Further, a resin known in the field of an electroconductive member for electrophotography can be used as the resin material. Specific examples thereof include an acrylic resin, polyurethane, polyamide, polyester, polyolefin, an epoxy resin, and a silicone resin. The following substance may be added to the rubber for forming the electroconductive resin layer in order to control its electrical resistance value as required: carbon black or graphite, which exhibits electron conductivity; an oxide such as tin oxide; a metal such as copper or silver; an electroconductive particle to which electroconductivity is imparted by coating the surface of the particle with an oxide or a metal; a quaternary ammonium salt, which exhibits ion conductivity; an ion conductive agent having ion exchange performance such as a sulfonic acid salt; or the like. In addition, a filler, softening agent, processing aid, tackifier, antitack agent, dispersant, foaming agent, roughening particle, or the like generally used as a compounding agent for a resin can be added to the extent that the effects of the present invention are not impaired. As a guideline on the electrical resistance value of the electroconductive resin layer according to the present invention, its volume resistivity is from 1×10² Ω·cm or more to 1×10¹⁰ Ω·cm or less.

<Fiber Layer>

[Average Fiber Diameter]

An average fiber diameter d of the fibers constituting the fiber layer is from 0.01 μm to 40 μm. Setting the average fiber diameter to 0.01 μm or more and μm or less can secure the strengths of the fibers themselves and improve the shape followability of the fiber layer to the surface shape of the electroconductive substrate. Accordingly, the adhesion property of the fiber layer to the electroconductive substrate is good. In addition, as long as the average fiber diameter is 40 μm or less, when the electroconductive member is used as a charging roller, a transfer roller, or the like, the pattern of the fibers hardly occurs as an image harmful effect on an image. In addition, the average fiber diameter is particularly preferably set to 0.1 μm or more and 5 μm or less. When the average fiber diameter falls within the range, the followability of the fibers to the shape of the electroconductive substrate can be additionally improved, and the strengths of the fibers themselves can be sufficiently secured.

It should be noted that the average fiber diameter d is the diameter of a section vertical to a fiber axis direction, and is the average of diameters at a total of 25 sites obtained as follows: the electroconductive member is divided in its longitudinal direction into 5 equal divisions and a fiber section is subjected to measurement at 5 arbitrary sites in each division. It should be noted that when the section vertical to the fiber axis direction is of an elliptical shape, the average of its longer diameter and shorter diameter is defined as its diameter.

An average thickness t of the fiber layer is preferably from 10 μm to 200 μm. It should be noted that the term “thickness of the fiber layer” as used herein refers to the thickness of the fiber layer measured in a direction vertical to the surface of the electroconductive substrate, and means the average of thicknesses at a total of 25 sites obtained as follows: the electroconductive member is divided in its longitudinal direction into 5 equal divisions and a segment that has been cut out is subjected to measurement at 5 arbitrary sites in each division. The thickness of the fiber layer can be measured by: cutting a segment including the electroconductive substrate and the fiber layer out of the electroconductive member in a state of being out of contact with any other member; and subjecting the segment to X-ray CT measurement.

In addition, in the fiber layer, the placement of the fibers preferably has low orientation. The fiber layer whose fibers have low orientation has the following advantage: the flexibility of the fiber layer is high, and hence when its shape changes owing to an environmental change, a load on its portion adhering to the electroconductive substrate reduces, and peeling between the electroconductive substrate and the fiber layer hardly occurs.

[Raw Material for Fibers]

A material serving as the raw material for the fibers forming the fiber layer in the present invention is not particularly limited as long as the material can be used as a liquid raw material and can form a fibrous structure, and examples thereof can include organic materials typified by a resin material.

Examples of the resin material include: a polyolefin-based polymer such as polyethylene or polypropylene; polystyrene; polyimide, polyamide, polyamide imide; a polyarylene (aromatic polymer) such as polyphenylene oxide, poly(2,6-dimethylphenylene oxide) or poly-p-phenylene sulfide; a fluorine-containing polymer such as polytetrafluoroethylene or polyvinylidene fluoride; a polybutadiene-based compound; a polyurethane-based compound such as an elastomer or gel; a silicone-based compound; polyvinyl chloride; polyethylene terephthalate; and polyarylate. It should be noted that one kind of those polymers may be used alone, or two or more kinds thereof may be used in combination. In addition, those polymers may be functionalized, or a copolymer produced from a combination of two or more kinds of monomers serving as raw materials for those polymers may be used.

A solvent to be used in preparing the liquid containing the material for the fibers is exemplified by methanol, ethanol, isopropanol, butanol, water, acetone, methyl ethyl ketone, methyl isobutyl ketone, toluene, xylene, tetrahydrofuran, 1,4-dioxane, dichloromethane, chloroform, 1,2-dichloroethane, chlorobenzene, dichlorobenzene, ethylene glycol monomethyl ether, ethylene glycol monoethyl ether, propylene glycol monomethyl ether, propylene glycol monoethyl ether, N-methylformamide, N,N-dimethylformamide, N-methylformanilide, N,N-dimethylacetamide, N-methylpyrrolidone, dimethyl sulfoxide, ethylene glycol monomethyl ether acetate, propylene glycol monomethyl ether acetate, cyclohexanone, benzyl ethyl ether, dihexyl ether, acetonylacetone, isophorone, caproic acid, caprylic acid, 1-octanol, 1-nonanol, benzyl alcohol, benzyl acetate, ethyl benzoate, diethyl oxalate, diethyl maleate, γ-butyrolactone, ethylene carbonate, propylene carbonate, and phenyl cellosolve acetate. A mixed solvent obtained by mixing two or more kinds of those solvents may be used.

In addition, the fibers can be made electroconductive by adding a carbonic electroconductive substance, a metal oxide, or the like to the liquid containing the raw material for the fibers depending on the applications of the electroconductive member. Examples of the carbonic electroconductive substance include graphite, carbon black, acetylene black, and ketjen black.

<Fiber-Forming Step>

In the method of producing an electroconductive member for electrophotography of the present invention, first, the liquid containing the raw material for the fibers is ejected from the nozzle toward the electroconductive substrate to produce the fibers in the space between the nozzle and the outer peripheral surface of the electroconductive substrate. The produced fibers are then adhered to the outer peripheral surface of the electroconductive substrate to form the fiber layer on the outer peripheral surface of the electroconductive substrate.

A method of ejecting the liquid containing the raw material for the fibers from the nozzle is, for example, an electrospinning method, a conjugate spinning method, a polymer blend spinning method, a melt-blow spinning method, or a flash spinning method. Of those production methods, an electrospinning method is preferred. In the electrospinning method, the step of producing the fibers and the step of adhering the fibers to the outer peripheral surface of the electroconductive substrate are performed in a state where an electric field is applied to the space between the nozzle and the outer peripheral surface of the electroconductive substrate. Accordingly, additionally good adhesion property can be obtained between the electroconductive substrate and the fiber layer. In addition, the fiber layer having a suitable fiber diameter can be stably formed at a low cost.

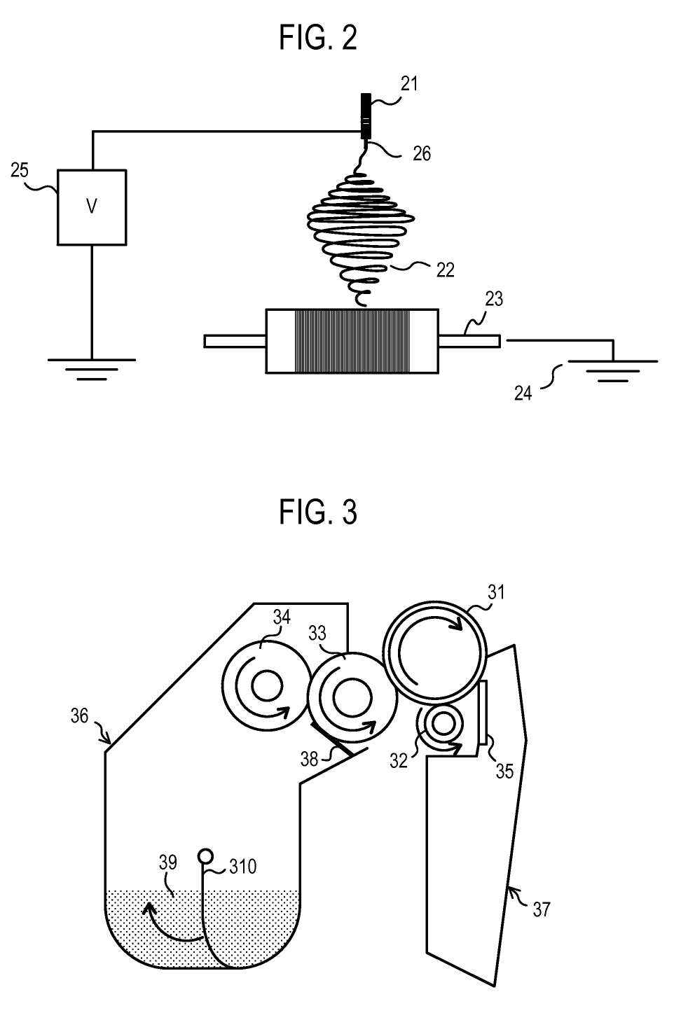

An example of a method of producing the fiber layer based on the electrospinning method is described with reference to FIG. 2. As illustrated in FIG. 2, an electrospinning apparatus includes a high-voltage power source 25, a tank 21 for storing the raw material liquid, and a nozzle 26, and an electroconductive substrate 23 attached to the apparatus is connected to a ground 24. The liquid containing the raw material for the fibers is pushed out of the tank to the nozzle at a constant speed. A voltage of from 1 to 50 kV is applied to the nozzle, and when an electrical attraction exceeds the surface tension of the raw material liquid, a jet 22 of the raw material liquid is injected toward the electroconductive substrate.

A raw material liquid containing a solvent, a molten resin obtained by heating a resin material to a temperature equal to or more than its melting point, or the like can be used as the raw material liquid. When the raw material liquid is the raw material liquid containing the solvent, the solvent in the jet gradually volatilizes, and the fibers are produced by the time the jet reaches the electroconductive substrate. The diameters of the fibers are reduced to several tens of micrometers or less, and the fibers are adhered and fixed along the surface shape of the electroconductive substrate.

When the raw material liquid is the molten resin, the molten resin pushed out of the nozzle gradually solidifies, and the fibers are produced by the time the molten resin reaches the electroconductive substrate. The diameters of the fibers are reduced to several tens of micrometers or less, and the fibers are adhered and fixed along the surface shape of the electroconductive substrate.

When the electroconductive member obtained by adhering the fiber layer to the outer peripheral surface of the electroconductive substrate is directly produced like the present invention, the fiber layer becomes seamless. It should be noted that an approach to producing the raw material liquid for electrospinning is not particularly limited, and a conventionally known method can be appropriately employed. Here, the kind of the solvent to be incorporated and the concentration of the solution are not particularly limited, and such conditions have only to be optimum for the electrospinning.

In addition, the electroconductive substrate and the fiber layer may be laminated and joined with an adhesive (pressure-sensitive adhesive) to the extent that the electrical characteristics of the electroconductive member are not impaired, and a conventionally known approach can be appropriately employed. In this case, the adhesion property between the electroconductive substrate and the fiber layer can be additionally improved.

In addition, in order that the fiber layer may be uniformly formed on the outer peripheral surface of the electroconductive substrate, the nozzle and the electroconductive substrate may be relatively moved in an arbitrary direction, or the electroconductive substrate may be rotated. At that time, when the speed at which the fibers are formed is set to be higher than a relative movement speed between the nozzle and the surface of the electroconductive substrate opposite to the nozzle, the orientation of the fibers reduces. Accordingly, the flexibility of the fiber layer improves, and hence when the electroconductive member is expanded or shrunk by a temperature or a humidity, the fiber layer having additionally good adhesion property can be formed. It should be noted that the speed at which the fibers are formed refers to the length of a fiber to be formed on the electroconductive substrate per unit time.

<Process Cartridge>

FIG. 3 is a schematic sectional view of a process cartridge for electrophotography including a developing device and a charging device. The electroconductive member produced by the production method of the present invention can be used as a charging roller 32 to be included in such process cartridge. The developing device is obtained by integrating at least a developing roller 33 and a toner container 36, and may include a toner supply roller 34, a toner 39, a developing blade 38, and a stirring blade 310 as required. The charging device is obtained by integrating at least a photosensitive drum 31 and the charging roller 32, and may include a cleaning blade 35 and a waste toner container 37. A voltage is adapted to be applied to each of the charging roller 32 and the developing roller 33.

<Electrophotographic Apparatus>

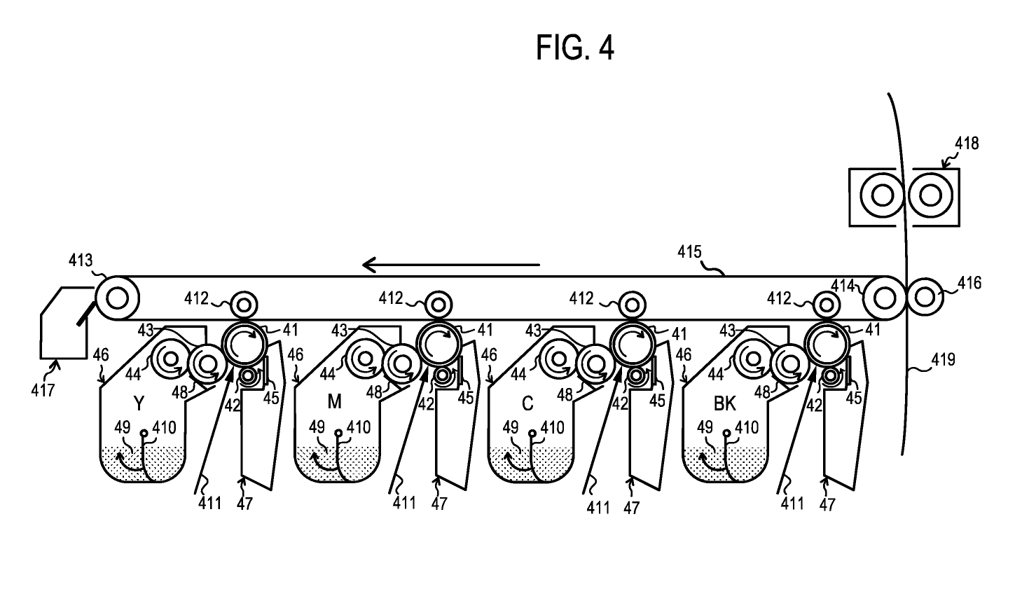

FIG. 4 is a schematic construction view of an electrophotographic image forming apparatus (hereinafter sometimes referred to as “electrophotographic apparatus”). For example, the electrophotographic image forming apparatus is provided with the process cartridge illustrated in FIG. 3 for each of black, magenta, yellow, and cyan toners, and is a color image forming apparatus to which the cartridge is detachably mounted.

A photosensitive drum 41 rotates in a direction indicated by an arrow and is uniformly charged by a charging roller 42 to which a voltage has been applied from a charging bias power source, and an electrostatic latent image is formed on its surface by exposure light 411. Meanwhile, a toner 49 stored in a toner container 46 is supplied to a toner supply roller 44 by a stirring blade 410 and conveyed onto a developing roller 43. Then, the surface of the developing roller 43 is uniformly coated with the toner 49 by a developing blade 48 placed so as to be in contact with the developing roller 43, and the toner 49 is provided with charge by triboelectric charging. The toner 49 conveyed by the developing roller 43 placed so as to be in contact with the photosensitive drum 41 is applied to the electrostatic latent image to develop the image. Thus, the image is visualized as a toner image.

The visualized toner image on the photosensitive drum is transferred onto an intermediate transfer belt 415, which is supported and driven by a tension roller 413 and an intermediate transfer belt driving roller 414, by a primary transfer roller 412 to which a voltage has been applied by a primary transfer bias power source. Toner images of the respective colors are sequentially superimposed to form a color image on the intermediate transfer belt.

A transfer material 419 is fed into the apparatus by a sheet feeding roller, and is conveyed into a gap between the intermediate transfer belt 415 and a secondary transfer roller 416. A voltage is applied from a secondary transfer bias power source to the secondary transfer roller 416, and the roller transfers the color image on the intermediate transfer belt 415 onto the transfer material 419. The transfer material 419 onto which the color image has been transferred is subjected to fixing treatment by a fixing unit 418 and discharged to the outside of the apparatus. Thus, a printing operation is completed.

Meanwhile, the toner remaining on the photosensitive drum without being transferred is scraped off the surface of the photosensitive drum by a cleaning blade 45 and stored in a waste toner storing container 47, and the cleaned photosensitive drum repeatedly performs the foregoing process. The toner remaining on the primary transfer belt (intermediate transfer belt) without being transferred is also scraped off by a cleaning device 417.

### EXAMPLE 1

1. Preparation of Unvulcanized Rubber Composition

Respective materials whose kinds and amounts were shown in Table 1 below were mixed with a pressure kneader to provide an A-kneaded rubber composition. Further, 156 parts by mass of the A-kneaded rubber composition, and respective materials whose kinds and amounts were shown in Table 2 below were mixed with an open roll to prepare an unvulcanized rubber composition.

TABLE 1

| | | Compounding |
|---|---|---|
| | | amount |
| | | (part(s) |
| | Material | by mass) |
| Raw material | NBR (trade name: Nipol DN219, | 100 |
| rubber | manufactured by ZEON | |
| | CORPORATION) | |
| Electro- | Carbon black (trade name: | 35 |
| conductive | TOKABLACK #7360SB, manufactured | |
| agent | by TOKAI CARBON CO., LTD.) | |
| Filler | Calcium carbonate (trade name: | 15 |
| | NANOX #30, manufactured by | |
| | Maruo Calcium Co., Ltd.) | |
| Vulcanizing | Zinc oxide | 5 |
| accelerator aid | | |
| Processing aid | Stearic acid | 1 |

TABLE 2

| | | Compounding |
|---|---|---|
| | | amount |
| | | (part(s) |
| | Material | by mass) |
| Crosslinking agent | Sulfur | 1.2 |
| Vulcanizing | Tetrabenzylthiuram disulfide | 4.5 |
| accelerator | (trade name: TBZTD, manufac- | |
| | tured by SANSHIN CHEMICAL | |
| | INDUSTRY CO., LTD.) | |

2. Production of Electroconductive Substrate

The following electroconductive roller was produced as the electroconductive substrate according to the present invention. A round bar having a total length of 252 mm and an outer diameter of 6 mm was prepared by subjecting the surface of free-cutting steel to electroless nickel plating treatment. Next, an adhesive was applied over the entire periphery of a 228-mm range excluding 12-mm ranges at both end portions of the round bar. An electroconductive and hot-melt type adhesive was used as the adhesive. In addition, a roll coater was used in the application. The round bar having applied thereto the adhesive was used as an electroconductive mandrel in this example.

Next, a crosshead extruder having a mechanism for supplying the electroconductive mandrel and a mechanism for discharging an unvulcanized rubber roller was prepared, a die having an inner diameter of 12.5 mm was attached to a crosshead, the temperatures of the extruder and the crosshead were adjusted to 80° C., and the speed at which the electroconductive mandrel was conveyed was adjusted to 60 mm/sec. The unvulcanized rubber composition was supplied from the extruder under the conditions to form a layer of the unvulcanized rubber composition on the outer peripheral surface of the electroconductive mandrel in the crosshead. Thus, the unvulcanized rubber roller was obtained. Next, the unvulcanized rubber roller was loaded into a hot-air vulcanizing furnace at 170° C. and heated for 60 minutes to provide an unground electroconductive roller. After that, the end portions of the elastic layer were cut and removed. Finally, the surface of the elastic layer was ground with a rotating grinding stone. Thus, an electroconductive roller having diameters at positions distant from its central portion toward both of its end portions by 90 mm each of 8.4 mm and a diameter at the central portion of 8.5 mm was obtained.

3. Preparation of Liquid Containing Raw Material for Fibers (Raw Material Liquid)

2.0 Grams of dimethylformamide (DMF) were added to 8.0 g of a polyamide imide solution obtained by dissolving polyamide imide (PAI) in a mixed solvent of methyl pyrrolidone (MNP) and xylene (manufactured by TOYOBO CO., LTD.: VYLOMAX HR-13NX, solid content concentration: 30 mass %) to adjust the solid content to 24.0 mass %. Thus, a raw material liquid No. 1 was prepared.

4. Production of Electroconductive Member

Next, the raw material liquid No. 1 was injected by an electrospinning method and the resultant fibers were directly adhered to the electroconductive roller. Thus, an electroconductive member according to the present invention having a fiber layer on the outer peripheral surface of the electroconductive substrate was produced.

That is, first, the electroconductive roller was installed in the collector portion of an electrospinning apparatus (manufactured by MECC CO., LTD.) and the electroconductive mandrel was connected to the ground. Next, a tank was filled with the raw material liquid No. 1. Then, while a voltage of 20 kV was applied to a nozzle (non-beveled needle G22), the raw material liquid No. 1 was ejected at a speed of 1.0 ml/h and the nozzle was moved at 57 mm/s in the axial direction of the electroconductive roller to inject the raw material liquid No. 1 toward the electroconductive roller. At that time, the stroke of the nozzle was set to 228 mm, which was equal to the width of the elastic layer of the electroconductive roller. In addition, the electroconductive roller was rotated at a peripheral speed of 500 mm/s. The raw material liquid No. 1 was injected for 72 seconds to provide an electroconductive member 1 having the fiber layer.

5. Characteristic Evaluation

Next, the resultant electroconductive member 1 was subjected to the following evaluation tests. Table 3 shows the results of the evaluations.

5-1. Measurement of Average Fiber Diameter

A scanning electron microscope (SEM) (observation with an S-4800 manufactured by Hitachi High-Technologies Corporation at a magnification of 2,000) was used in the measurement of the diameters of the fibers forming the fiber layer. First, 0.05 g of the fiber layer was stripped off the electroconductive member and platinum was deposited from the vapor onto the surface of the fiber layer. Next, the fiber layer onto which platinum had been deposited from the vapor was embedded using an epoxy resin and a section was shaped with a microtome, followed by observation with the SEM. At the time of the observation with the SEM, 5 fibers each having a sectional shape close to a circular shape were selected at random and their respective fiber diameters were measured. It should be noted that the average of the diameters of a total of 25 fibers measured as follows was defined as the average fiber diameter d: the electroconductive member was divided in its longitudinal direction into 5 equal divisions and each of the divisions was subjected to the foregoing measurement.

5-2. Average Thickness of Fiber Layer

First, a rectangular parallelepiped-shaped segment having the following sizes was cut out of the electroconductive member 1 with a razor: the segment was a 250-μm square in the outer surface of the fiber layer and had a length of 700 μm, which included the rubber roller as the electroconductive substrate, in the thickness direction of the fiber layer. It should be noted that when the electroconductive substrate was constituted only of the mandrel, only the fiber layer was cut out. Next, the segment was subjected to three-dimensional reconstruction with an X-ray CT inspection apparatus (trade name: TOHKEN-SkyScan2011 (radiation source: TX-300), manufactured by MARS TOHKEN X-RAY INSPECTION Co., Ltd.). The direction of the resultant three-dimensional image parallel to the outer surface of the electroconductive substrate was defined as an xy plane and its direction vertical thereto was defined as a z-axis direction, and two-dimensional slice images (parallel to the xy plane) were cut out of the image at an interval of 1 μm with respect to the z-axis. Next, the resultant slice images were binarized, and their fiber portions and hole portions were identified. The ratio of the fiber portion in each of the binarized slice images was converted into a numerical value, and the point at which the ratio of the fiber portion (area of fiber portion/(area of fiber portion+area of hole portion)×100 (%)) became 2% or less when such numerical value was confirmed along a direction from the electroconductive substrate toward the outer surface (z-axis direction) was defined as the outermost surface portion of the fiber layer. The thickness of the fiber layer was measured by the foregoing method.

It should be noted that the average of the thicknesses of a total of 25 sites obtained as follows was defined as the average thickness t of the fiber layer: the electroconductive member 1 was divided in its longitudinal direction into 5 equal divisions and the foregoing operations were performed at 5 arbitrary sites in each division.

6. Image Evaluation

Next, the electroconductive member 1 was subjected to the following evaluation test. Table 3 shows the result of the evaluation. An electrophotographic laser printer (trade name: Color Laserjet CP3525dn, manufactured by Hewlett-Packard Company) was prepared as an electrophotographic apparatus. First of all, the electroconductive member 1 was left to stand under a low-temperature and low-humidity environment (having a temperature of 10° C. and a relative humidity of 20%) for 24 hours, and was then left to stand under a high-temperature and high-humidity environment (having a temperature of 40° C. and a relative humidity of 95%) for 24 hours. After the process had been repeated 5 times, the electroconductive member 1 was incorporated as a charging member into the cartridge of the electrophotographic apparatus and subjected to an image evaluation. The entire image evaluation was performed under an environment having a temperature of 23° C. and a relative humidity of 50%, and was performed by outputting a halftone image (image in which horizontal lines each having a width of 1 dot were drawn in a direction vertical to the rotation direction of a photosensitive member at an interval of 2 dots). The resultant image was evaluated by the following criteria.
A: Image density unevenness due to the peeling of the fiber layer is absent.
B: Slight density unevenness due to the peeling of the fiber layer is partially observed.
C: Remarkable density unevenness due to the peeling of the fiber layer is observed.

### EXAMPLE 2

An electroconductive member 2 was produced and evaluated in the same manner as in Example 1 except that the production conditions were changed to conditions shown in Table 3.

### EXAMPLE 3

50 Milligrams of carbon black (TOKABLACK manufactured by TOKAI CARBON CO., LTD.) and 1 mL of dimethylformamide (DMF) were subjected to ball mill treatment for 60 minutes. Next, a liquid obtained by dissolving 180 mg of PA12 (manufactured by Arkema) and 180 mg of PA610 (manufactured by Daicel-Evonik Ltd.) in 72 mL of DMF was added to the mixture, and then the whole was subjected to the ball mill treatment for an additional 60 minutes to produce a raw material liquid No. 3 having dispersed therein electroconductive agents. An electroconductive member 3 was produced and evaluated in the same manner as in Example 1 except that the raw material liquid No. 3 was used and the production conditions were changed to conditions shown in Table 3.

### EXAMPLE 4

A raw material liquid No. 4 was produced by adding DMF to the raw material liquid No. 1 so that the solid content concentration became 15.0 mass %. An electroconductive member 4 was produced and evaluated in the same manner as in Example 1 except that the raw material liquid No. 4 was used and the production conditions were changed to conditions shown in Table 3.

### EXAMPLE 5

A raw material liquid No. 5 was produced by concentrating the raw material liquid No. 1 so that the solid content concentration became 33.0 mass %. An electroconductive member 5 was produced and evaluated in the same manner as in Example 1 except that the raw material liquid No. 5 was used and the production conditions were changed to conditions shown in Table 3.

### EXAMPLE 6

A stepped round bar having a total length of 252 mm, an outer diameter in a range from each of both of its end portions to a portion distant therefrom by 12 mm of 6 mm, and an outer diameter at the other central portion of 8.5 mm was prepared as the electroconductive substrate according to the present invention by subjecting the surface of free-cutting steel to electroless nickel plating treatment. In addition, an electroconductive member 6 was produced and evaluated in the same manner as in Example 1 except that the raw material liquid No. 1 was used and production conditions shown in Table 3 were adopted.

### EXAMPLE 7

5 Grams of nylon 66 (Amilan CM3007 manufactured by Toray Industries, Inc.) were loaded into a tank having a volume of 10 mL and the tank was heated to 300° C. Thus, a raw material liquid No. 7 (molten resin) was prepared. In addition, a spinneret (having a pore diameter of 0.15 mm) was prepared as a nozzle and heated to 300° C. Next, the raw material liquid No. 7 was ejected from the nozzle by a melt spinning method to produce fibers. An electroconductive member 7 was produced by directly adhering the fibers to the electroconductive roller in the same manner as in Example 1 except that conditions for the ejection from the nozzle and operating conditions for the electrospinning apparatus were changed to production conditions shown in Table 3, and the member was evaluated in the same manner as in Example 1.

### EXAMPLE 8

An electroconductive member 8 was produced and evaluated in the same manner as in Example 7 except that the same stepped round bar as that of Example 6 was used as the electroconductive substrate.

### EXAMPLE 9

The same electrophotographic laser printer as that of Example 1 was prepared. An electroconductive member 9 produced in the same manner as in Example 1 was left to stand under a low-temperature and low-humidity environment (having a temperature of 10° C. and a relative humidity of 20%) for 24 hours, and was then left to stand under a high-temperature and high-humidity environment (having a temperature of 40° C. and a relative humidity of 95%) for 24 hours. The process was repeated 5 times. The electroconductive member was incorporated as the secondary transfer roller (416 of FIG. 4) of the electrophotographic laser printer into the printer and subjected to the same image evaluation as that of Example 1.

TABLE 3

| | Example | | | | | | | | |
|---|---|---|---|---|---|---|---|---|---|
| | 1 | 2 | 3 | 4 | 5 | 6 | 7 | 8 | 9 |
| Production condition | | | | | | | | | |
| Ejection time | 72 | 72 | 36 | 64 | 144 | 80 | 8 | 8 | 72 |
| (second(s)) | | | | | | | | | |
| Ejection speed | 1 | 1 | 0.1 | 1 | 1.5 | 1 | 52 | 52 | 1 |
| (ml/h) | | | | | | | | | |
| Nozzle movement | 57 | 114 | 57 | 57 | 57 | 57 | 228 | 228 | 57 |
| speed (mm/s) | | | | | | | | | |
| Peripheral speed | 500 | 750 | 750 | 500 | 500 | 500 | 4,000 | 4,000 | 500 |
| (mm/s) | | | | | | | | | |
| Applied voltage | 20 | 22 | 22 | 20 | 20 | 20 | — | — | 20 |
| (kV) | | | | | | | | | |
| Electro- | Electro- | Electro- | Electro- | Electro- | Electro- | Stepped | Electro- | Stepped | Electro- |
| conductive | conductive | conductive | conductive | conductive | conductive | round | conductive | round | conductive |
| substrate | roller | roller | roller | roller | roller | bar | roller | bar | roller |
| Fiber layer | | | | | | | | | |
| Raw material | No. 1 | No. 1 | No. 3 | No. 4 | No. 5 | No. 1 | No. 7 | No. 7 | No. 1 |
| liquid No. | | | | | | | | | |
| Average fiber | 0.98 | 0.95 | 0.01 | 0.21 | 9.92 | 0.97 | 39.60 | 32.20 | 0.98 |
| diameter (μm) | | | | | | | | | |
| Average thickness | 79.7 | 72.5 | 11.5 | 48.9 | 198.5 | 97.4 | 199.2 | 175.5 | 79.7 |
| (μm) | | | | | | | | | |
| Image evaluation | | | | | | | | | |
| ensity unevenness | A | A | A | A | A | A | B | B | A |
| evaluation | | | | | | | | | |

### COMPARATIVE EXAMPLE 1

An electroconductive member C1 was produced and evaluated in the same manner as in Example 7 except that a spinneret (having a pore diameter of 0.3 mm) was used as the nozzle. In the image evaluation, remarkable density unevenness due to the peeling of the fiber layer (density unevenness evaluation: C rank) was observed. It should be noted that the average fiber diameter of the fibers of the fiber layer was 65.2 μm.

### COMPARATIVE EXAMPLE 2

An electroconductive roller obtained in the same manner as in Example 1 was rotated at 160 rpm, and a commercial nylon fiber having a length of 2,000 mm (SPECTRON AYU SEIHA XP 0.1 manufactured by DAIWA) was wound around the elastic layer so as to cover its width. Further, in order for peeling from the end portions of the nylon fiber to be prevented, the end portions were fixed at sites having no influences on an output image. Thus, an electroconductive member C2 was obtained. The average fiber diameter of the fibers of the fiber layer was 52 μm.

The resultant electroconductive member was subjected to the same evaluation as that of Example 1. As a result, in the image evaluation, remarkable density unevenness due to the peeling of the fiber layer (density unevenness evaluation: C rank) was observed.

### COMPARATIVE EXAMPLE 3

A commercial nylon nonwoven fabric cut so as to have a width of 20 mm (ELTAS NYLON N01030 manufactured by Asahi Kasei Corporation) was wound around an electroconductive roller obtained in the same manner as in Example 1 in a spiral manner so that neither a gap nor overlapping occurred, and the end surfaces of the fabric were fixed at sites having no influences on an output image. Thus, an electroconductive member C3 was obtained.

The electroconductive member was subjected to the same evaluation as that of Example 1. As a result, in the image evaluation, remarkable density unevenness due to the peeling of the fiber layer (density unevenness evaluation: C rank) was observed. In addition, density unevenness due to a seam of the nonwoven fabric was also observed.

According to the present invention, it is possible to provide the electroconductive member for electrophotography, having a fiber layer on the outer peripheral surface of an electroconductive substrate, the electroconductive member having good adhesion property between the electroconductive substrate and the fiber layer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-202660, filed on Sep. 27, 2013, which is hereby incorporated by reference herein in its entirety.

What is claimed is:

1. A method of producing an electroconductive member for electrophotography,
the electroconductive member comprising
an electroconductive substrate; and
a fiber layer thereon, the fiber layer comprising fibers which have an average fiber diameter of from 0.01 μm to 40 μm, and are adhered to an outer peripheral surface of the electroconductive substrate,
the method comprising the steps of:
(1) producing the fibers in a space between a nozzle and the outer peripheral surface of the electroconductive substrate by ejecting a liquid containing a raw material for the fibers from the nozzle toward the electroconductive substrate; and
(2) adhering the fibers to the outer peripheral surface of the electroconductive substrate.

2. A method of producing an electroconductive member for electrophotography according to claim 1, wherein the step (2) comprises adhering the fibers to the outer peripheral surface of the electroconductive substrate while relatively moving the nozzle and the electroconductive substrate.

3. A method of producing an electroconductive member for electrophotography according to claim 1, wherein the step (1) and the step (2) are performed in a state where an electric field is applied to the space between the nozzle and the outer peripheral surface of the electroconductive substrate.

4. A method of producing an electroconductive member for electrophotography according to claim 1, wherein the fiber layer has an average thickness of from 10 μm to 200 μm.

5. A method of producing an electroconductive member for electrophotography according to claim 1, wherein the liquid containing the raw material for the fibers contains a resin material and a solvent.

6. A method of producing an electroconductive member for electrophotography according to claim 5, wherein the resin material comprises at least one kind selected from the group consisting of a polyolefin-based polymer, polystyrene, polyimide, polyamide, polyamide imide, a polyarylene, a fluorine-containing polymer, a polybutadiene-based compound, a polyurethane-based compound, a silicone-based compound, polyvinyl chloride, polyethylene terephthalate, and polyarylate.

7. A method of producing an electroconductive member for electrophotography according to claim 5, wherein the solvent comprises at least one kind selected from the group consisting of methanol, ethanol, isopropanol, butanol, water, acetone, methyl ethyl ketone, methyl isobutyl ketone, toluene, xylene, tetrahydrofuran, 1,4-dioxane, dichloromethane, chloroform, 1,2-dichloroethane, chlorobenzene, dichlorobenzene, ethylene glycol monomethyl ether, ethylene glycol monoethyl ether, propylene glycol monomethyl ether, propylene glycol monoethyl ether, N-methylformamide, N,N-dimethylformamide, N-methylformanilide, N,N-dimethylacetamide, N-methylpyrrolidone, dimethyl sulfoxide, ethylene glycol monomethyl ether acetate, propylene glycol monomethyl ether acetate, cyclohexanone, benzyl ethyl ether, dihexyl ether, acetonylacetone, isophorone, caproic acid, caprylic acid, 1-octanol, 1-nonanol, benzyl alcohol, benzyl acetate, ethyl benzoate, diethyl oxalate, diethyl maleate, γ-butyrolactone, ethylene carbonate, propylene carbonate, and phenyl cellosolve acetate.

8. A method of producing an electroconductive member for electrophotography according to claim 1, wherein the liquid containing the raw material for the fibers comprises a molten resin obtained by heating a resin material to a temperature equal to or more than a melting point thereof.

9. A method of producing an electroconductive member for electrophotography according to claim 8, wherein the resin material comprises polyamide.

10. A method of producing an electroconductive member for electrophotography,
the electroconductive member comprising
an electroconductive substrate; and
a fiber layer thereon, the fiber layer comprising fibers which have an average fiber diameter of from 0.01 μm to 40 μm, and are adhered to an outer peripheral surface of the electroconductive substrate, the method comprising the steps of:
producing the fibers in a space between a nozzle and the outer peripheral surface of the electroconductive substrate by ejecting a liquid containing a raw material for the fibers from the nozzle toward the electroconductive substrate by applying a voltage to the nozzle; and
adhering the fibers to the outer peripheral surface of the electroconductive substrate.
